(19) United States
(12) Patent Application Publication
(10) Pub. No.: US 2009/0045078 A1
(43) Pub. Date: Feb. 19, 2009

(54) Container With Selectively Deactivatable Locking Feature

(76) Inventors: John Gelardi, Wake Forest, NC (US); Timothy Freeze, Mebane, NC (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/022,806

(22) Filed: Jan. 30, 2008

Related U.S. Application Data
(60) Provisional application No. 60/955,492, filed on Aug. 13, 2007.

(51) Int. Cl. A61J 1/03; B65D 83/04; B65D 50/06

(52) U.S. Cl. 206/1.5; 206/531; 220/694

(57) ABSTRACT

A lockable container includes a lockable sleeve and a slideable platform. The slideable platform can be stored in the lockable sleeve. The sleeve and the slideable platform can each have one or more of an engaging mechanism and a receiving mechanism, with reciprocal engaging mechanisms and/or receiving mechanisms being included at the other element. A release button can be included in the sleeve to disengage the engaging mechanism from the receiving mechanism. A deactivation tool can be provided that selectively prevents the engaging mechanism from engaging the receiving mechanism. The tool can be a stand-alone part, or can be joined to a jacket or a deactivation clip. The jacket can be slideably attached to the sleeve, and the deactivation clip can be inserted into or clipped onto the sleeve.

### RELATED APPLICATION

This application claims priority to U.S. Provisional Patent Application No. 60/955,492, filed Aug. 13, 2007, the entirety of which is hereby incorporated by reference.

### TECHNICAL FIELD

The present disclosure relates generally to child-resistant containers. More specifically, the present disclosure relates to a child-resistant container having a selectably deactivatable locking feature.

### BACKGROUND

Child-resistant or lockable containers, wherein multiple movements are required to open the container, have many uses. One use for a lockable container is to control the dispensing of medicine and medicaments in the form of pills and tablets. For example, locking caps on medicine bottles are well known. The typical locking cap mechanism requires a coordinated alignment and tipping, or axial pressure, or inward radial squeezing while turning the cap to remove it from its container in order to access the medicaments.

By way of another example, medicines are packaged in convenient flat boxes, which are difficult to secure with child-resistant features. Many medicaments in the form of tablets are sold in blister packs—blisters formed on a sheet sealed by a barrier that is punctured when extracting a tablet from a blister. When a typical cardboard flat box holding one or more blister packs is opened the entire contents of the package is exposed, making all of the tablets immediately available. The dangers posed by children with access to a large quantity of tablets not intended for their consumption is self evident.

### SUMMARY

The illustrated embodiments of the present disclosure are directed to a child-resistant lockable container for storage and dispensing of medications packaged with a slideable member that holds items, for example, a tray, a drawer with compartments, a blister card, a blister pack, or the like (“slideable card”). The slideable card is illustrated as a conventional blister package, but the slideable member can be a tray, a slideable package, or any other packaging, as is known to those skilled in the art. The lockable container is illustrated as a two-piece molded plastic container closed on three sides to form a void that receives the slideable card. The slideable card slideably translates through the open forth side of the lockable container. Posts molded on one piece of the lockable container are connected, and in some embodiments sealed or welded, with the corresponding hollow cylinders molded on the other piece of the lockable container. Other attachment mechanisms can be used, and use of such other mechanisms is contemplated.

The lockable container can include one or more locking features. The locking features can include, for example, one or more posts, apertures, catches, lips, hooks, adhesives, metallic and/or magnetic surfaces, VELCRO® fasteners, or other engaging mechanisms (“post”) formed on one or both of the two pieces of the lockable container. When the slideable card is inserted into the container, the engaging mechanisms of the container can engage, for example, one or more apertures, posts, catches, lips, hooks, adhesives, metallic and/or magnetic surfaces, VELCRO® fasteners, or other receiving mechanisms (“aperture”) formed on or in the slideable card. A release button is located on the lockable container, and is positioned proximate to the post. One or more ribs, springs, and/or other biasing mechanisms can be located proximate the engaging or receiving mechanisms to exert a compressive force upon, and thereby urge, the engaging mechanism to engage the receiving mechanism. Pressing the release button manipulates the slideable card to disengage the engaging and receiving mechanisms so that the slideable card can be slideably removed.

At times, it may be desirable to deactivate the locking features of the lockable container. Therefore, the present disclosure is additionally directed to providing structures and methods for deactivation the locking features of the lockable container.

According to some embodiments, the lock deactivation feature includes a tool for interfacing with the engaging mechanism, the receiving mechanism, or both. The tool can be any desired shape, including, but not limited to, wedge-shaped, disc-shaped, or tab-shaped. When a user wants to deactivate the locking feature of the lockable container, the tool, or a portion thereof, e.g., an edge, can be used to depress the release button of the lockable container. In other embodiments, the tool, or a portion thereof, can be inserted into the lockable container. The inserted tool, or a portion thereof, can prevent the engaging mechanism from engaging the receiving mechanism. According to other embodiments, the tool can compliment the receiving mechanism, the engaging mechanism, or both, thereby preventing engagement of the engaging mechanism and the receiving mechanism.

According to some embodiments, the tool is inserted into the container by interfacing with the release button. In other embodiments, the container includes extra slots or apertures for insertion of the tool. In still other embodiments, the tool is partially integrated into the container and is slideably engaged or disengaged to and from a deactivation position. The tool can also be connected to a deactivation clip that can be attached to the locking container. The deactivation clip includes a tool, or key, and can include one or more engaging arms and one or more edges.

According to some embodiments, the tool can be included on a jacket that wraps around the sleeve. In other embodiments, the tool can be a stand-alone part for insertion into the container without any additional tools. Even if the tool is a stand-alone part, some embodiments provide attachment mechanisms to ensure that the tool does not move out of an engaged or disengaged position.

Accordingly, an embodiment of the disclosure includes a storing and dispensing system. The storing and dispensing system includes a sleeve, a sliding platform, and a deactivation tool. The sleeve includes a first side connected to a second side to form a void for receiving the sliding platform. The sleeve also includes an open end configured to permit the sliding platform to translate between a first position and a second position. A first engaging element is positioned substantially within the void. The sliding platform includes a second engaging element for engaging the first engaging element. The deactivation tool is selectively positioned to prevent the first engaging element from engaging the second engaging element.

According to an aspect of the disclosure, the first engaging element includes a post.

According to another aspect of the disclosure, the second engaging element includes an aperture.

According to another aspect of the disclosure, the sleeve also includes a release proximate the first engaging element, and the deactivation tool includes an edge that can at least partially displace the release.

According to another aspect of the disclosure, the edge includes a notch.

According to another aspect of the disclosure, the sleeve includes one or more securing tabs for retaining at least a portion of the deactivation tool when the deactivation tool is positioned to prevent the first engaging element from engaging the second engaging element.

According to another aspect of the disclosure, the deactivation tool is substantially disc-shaped.

According to another aspect of the disclosure, the sleeve includes a slot through which the deactivation tool is selectively inserted to prevent the first engaging element from engaging the second engaging element.

According to another aspect of the disclosure, the deactivation tool is a flap.

According to another aspect of the disclosure, the flap is slideably coupled to the sleeve.

According to another aspect of the disclosure, the deactivation tool is a slideable card.

According to another aspect of the disclosure, the slideable card includes a flap.

According to another aspect of the disclosure, the slideable card includes a third engaging element and a flap. The third engaging element engages the first engaging element, and the flap prevents the second engaging element from engaging the first engaging element.

According to another embodiment of the disclosure, a selectively lockable container includes a sleeve, a sliding platform, and a deactivation tool insertion port. The sleeve includes a first side connected to a second side to form a void for receiving the sliding platform. The sleeve also includes an open end configured to permit the sliding platform to translate between a first position and a second position. A first engaging element is positioned substantially within the void. The sliding platform includes a second engaging element for engaging the first engaging element. The deactivation tool insertion port is an opening in the sleeve through which at least a portion of a deactivation tool is passed to selectively prevent the first engaging element from engaging the second engaging element.

According to an aspect of the disclosure, the deactivation tool insertion port is the open end of the container.

According to another aspect of the disclosure, the first engaging element is a post and the second engaging element is an aperture.

According to another aspect of the disclosure, the deactivation tool insertion port is an aperture that at least partially defines the release.

According to another aspect of the disclosure, the lockable container includes a release proximate the first engaging element. The deactivation tool selectively moves the release into a disengagement position, whereat the first engaging element is prevented from engaging the second engagement element.

According to another aspect of the disclosure, the sleeve includes at least one securing tab for retaining at least a portion of the deactivation tool when the deactivation tool is used to move the release into the disengagement position.

According to another aspect of the disclosure, the further comprising an attachment mechanism configured to attach the deactivation tool to the sleeve. The attachment mechanism can be tape.

According to another embodiment of the disclosure, a storing and dispensing system includes a sleeve, a sliding platform, and a deactivation clip. The sleeve includes a first side connected to a second side to form a void for receiving the sliding platform. The sleeve can also include an open end configured to permit the sliding platform to translate between a first position and a second position. A first engaging element is positioned substantially within the void. The sliding platform includes a second engaging element for engaging the first engaging element. The deactivation clip includes a key configured to prevent the first engaging element from engaging the second engaging element.

According to another embodiment of the disclosure, a deactivation clip for selectively preventing a first engaging element from engaging a second engaging element includes a key configured for insertion into a lockable case through an access port formed in the lockable case.

According to an aspect of the disclosure, the deactivation clip includes at least one engaging edge attached to the key.

According to another aspect of the disclosure, the deactivation clip includes at least one engaging arm connected to the at least one engaging edge.

According to another aspect of the disclosure, the deactivation clip includes two engaging arms and two engaging edges.

### BRIEF DESCRIPTION OF THE DRAWINGS

FIG. 1 is a perspective view of a lockable container, according to an exemplary embodiment of the present disclosure.

FIGS. 2 and 3 are exploded views of the lockable container of FIG. 1.

FIGS. 4-6 are partial perspective views of a lockable container, according to another exemplary embodiment of the present disclosure.

FIGS. 7 and 8 are perspective views of a lockable container, according to another exemplary embodiment of the present disclosure.

FIGS. 9 and 10 are partial perspective views of a lockable container, according to another exemplary embodiment of the present disclosure.

FIG. 11 is a cross-sectional partial side elevation view of the lockable container of FIGS. 9 and 10.

FIGS. 12 and 13 are perspective views of a lockable container, according to another exemplary embodiment of the present disclosure.

FIG. 14 is a partial perspective view of the interior of the lockable container of FIGS. 12 and 13.

FIGS. 15 and 16 are perspective views of a lockable container, according to another exemplary embodiment of the present disclosure.

FIG. 17 is a partial perspective view of the interior of the lockable container of FIGS. 15 and 16.

FIG. 18 is a partial perspective view of a lockable container, according to another exemplary embodiment of the present disclosure.

FIGS. 19 and 20 are partial perspective views of the interior of a lockable container, according to another exemplary embodiment of the present disclosure.

FIGS. 21-23 are partial perspective views of a card and the interior of a lockable container, according to another exemplary embodiment of the present disclosure.

FIG. 24 illustrates an exemplary deactivation clip for use with a lockable container, according to another exemplary embodiment of the present disclosure.

### DETAILED DESCRIPTION

As required, detailed embodiments of the present disclosure are disclosed herein. It must be understood that the disclosed embodiments are merely exemplary examples of the disclosure that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

For purposes of teaching, the illustrated embodiments are shown and described in the context of a lockable container that includes a blister pack or blister card, which is configured to store and dispense pharmaceutical-related goods. However, the lockable container can be utilized to store and dispense other items, and can be specifically useful for small, delicate, sensitive, or portable items. Examples of such items include all manner of consumable products such as candy, food, vitamins, and the like; and all manner of personal care products such as contact lens, birth control devices, smoking cessation patches, hearing aid batteries, and the like.

Further, the lockable container can be configured to store and dispense items that are not packaged in a blister card but in any slidable platform. In such embodiments, the blister card packaging can be substituted with a tray, card, rack, pack, pouch, or the like. In general, the teaching provided herein are applicable to any structure that holds or stores an item, that provides a basis for attaching or securing an item thereto, or that is otherwise associated with an item.

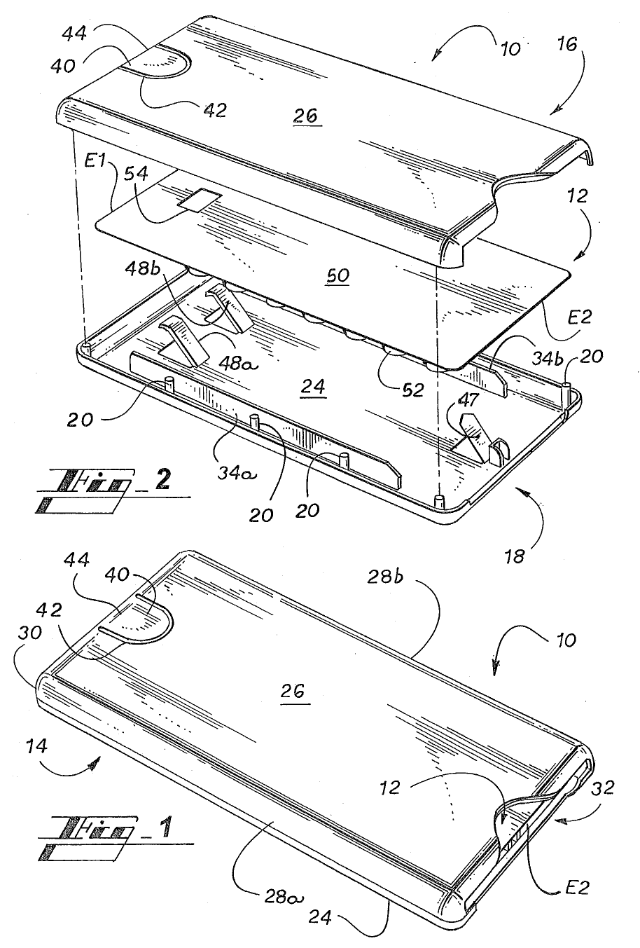

Referring now to the drawings, wherein like numerals represent like features throughout, embodiments of the present disclosure are illustrated. Turning to an exemplary embodiment illustrated in FIGS. 1-3, a lockable container 10 includes a blister card 12 that cooperates with a locking sleeve 14 to dispense and store items such as medicaments (not shown).

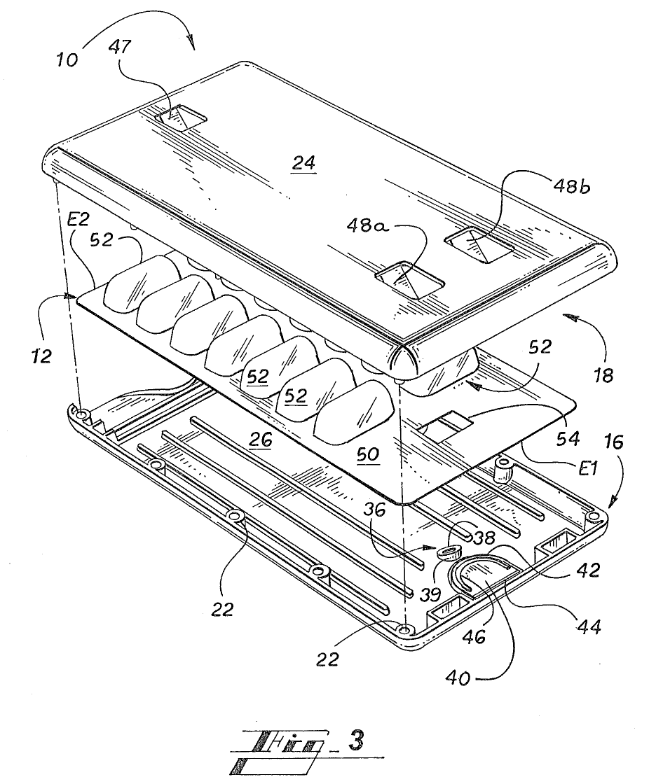

Referring to FIGS. 2 and 3, the illustrated sleeve 14 is formed from a base portion 16 and a top portion 18 that are attached to one another, as shown in FIG. 1. Specifically, the base portion 16 and the top portion 18 are attached to one another as pegs or pins 20 are press fit in hollow cylinders 22. In alternative embodiments, it is contemplated that the sleeve 14 can be a unitary structure or that the top and bottom portions 16, 18 can be attached to one another by elements that provide a snap connection, welding, elements that provide a sliding connection, mechanical fasteners, glue or other adhesives, other attachment mechanisms, combinations thereof, and the like.

The sleeve 14 includes a top wall 24, a base wall 26, and opposing outer side walls 28a, 28b that define a tubular structure. One end of the tubular structure is enclosed by an end wall 30 and the other end is a substantially open end 32. The sleeve 14 includes a compartment that is dimensioned to receive the blister card 12 and to align features of the blister card 12 with features of the sleeve 14. In the illustrated embodiment, inner side walls of the compartment are defined by ribs 34a, 34b that are inwardly offset from the outer side walls 28a, 28b, the top wall 24, the base wall 26, and the end wall 30.

The illustrated sleeve 14 includes a locking post 36 that projects into the compartment from the base wall 26. It should be appreciated that the locking post 36 is merely exemplary as an embodiment of an engaging mechanism. The engaging mechanism 36 can be any element that can cooperatively engage a receiving mechanism of the sliding platform, as will be described in detail below. The illustrated locking post 36 is adjacent the end wall 30 and is shaped so as to lift and engage the blister card 12 as the blister card 12 is substantially fully inserted into the compartment. Specifically, the locking post 36 includes a sloped surface 38 that faces the open end 32 of the sleeve 14. The locking post 36 also includes a contacting surface 39, for engaging the blister card 12 as described below. The contacting surface 39 is opposite the sloped surface 38 so as to face the end wall 30.

The sleeve 14 includes a release button 40 that, here, is defined by a U-shaped slot 42 and a hinge 44 so as to be pivotally displaceable into the compartment. The release button 40 is disposed in the base wall 26 between the locking post 36 and the end wall 30 with the distal end of the release button 40 being adjacent the contacting surface 39 of the locking post 36. The illustrated release button 40 includes a rib extension 46 that extends into the compartment to facilitate contacting and displacing the blister card 12, as described in further detail below.

The illustrated sleeve 14 includes a retainer structure 47 that is dimensioned and positioned to allow the blister card 12 to freely slide into the compartment and to engage the blister card 12 as the blister card 12 is removed from the compartment. The illustrated retainer structure 47 is positioned near the open end 32 and extends from the top wall 24 into the compartment and towards both the end wall 30 and the base wall 26.

Ribs, springs, or other biasing elements 48a, 48b, extend from the top wall 24 into the compartment, to urge or bias the blister card 12 towards the base wall 26. Alternative biasing elements include leaf springs, dagger springs, and similar elements that exert a compressive force. In alternative embodiments, ribs that direct the blister card 12 toward the base wall 26 are the biasing elements 48a, 48b.

The sliding platform in the form of a blister card 12 is now described in further detail. The illustrated blister card 12 includes a planar substrate 50 and a plurality of blisters 52 that typically hold one or more items such as medicaments (not shown). The blisters 52 are arranged so as to avoid contact with certain internal features of the sleeve 14 when the blister card 12 is translated inwardly or outwardly. For purposes of describing the orientation of the blister card 12, a leading edge E1 and a trailing edge E2 are defined.

According to an exemplary method of forming a blister card 12 and packaging items (not shown) therein, blisters 52 are formed in a planar plastic sheet to provide a tray and items are placed in the recesses provided by the blisters 52. Thereafter, a backing, such as a sheet of paperboard or foil, is attached to the planar portion of the tray to enclose the items in the blisters 52. According to this formation of a blister card 12, the planar substrate 50 is defined by laminated layers provided by the plastic sheet and paperboard or foil backing.

The blister card 12 includes an engaging aperture 54 that is dimensioned and positioned to receive the locking post 36. It should be understood, however, that the engaging aperture 54 is merely an exemplary embodiment of a receiving mechanism. The receiving mechanism 54 can be any element that can cooperatively engage the engaging mechanism 36. In the illustrated embodiment, the aperture 54 is positioned near the leading edge E1. The compartment and the blister card 12 are dimensioned with respect to one another such that, when the blister card 12 is substantially, fully inserted into the compartment, the engaging aperture 54 is positioned or aligned to receive the locking post 36. The width of the illustrated compartment is substantially that of the illustrated blister card 12.

The blister card can be alternatively configured and/or formed according to alternative methods. For example the blister card 12 can include an alternative number of blisters 52 and/or blisters 52 that are alternatively arranged. As another example, the blister cards 12 can taper or narrow towards the leading edge E1 to facilitate being received in the sleeve 14.

A method of operating the lockable container 10 is now described. In the illustrated embodiment, a locking feature that releasably locks the blister card 12 within the sleeve 14 includes the locking post 36, the biasing elements 48a, 48b, and the engaging aperture 54. To releasably lock the blister card 12 in the sleeve 14, the leading edge E1 of the blister card 12 is inserted through the open end 32 of the sleeve 14 with the blisters 52 being adjacent the top wall 24. As the blister card 12 slides into the compartment, the leading edge E1 slides over the sloped surface 38 and the locking post 36 is received in the aperture 54. Thereafter, the contacting surface 39 contacts the edge of the aperture 54 to releasably lock the blister card 12 in the sleeve 14. Further, the biasing elements 48a, 48b push the blister card 12 toward the base wall 26 to hold the aperture 54 in a position whereat the aperture 54 is engaged with the locking post 36.

In the illustrated embodiment, a releasing feature for releasing the blister card 12 from the sleeve 14 includes the release button 40. To release the blister card 12 from the sleeve 14, the release button 40 is pressed into the compartment such that the rib extension 46 contacts the blister card 12 and displaces the blister card 12 toward the top wall 24. The blister card 12 pushes against the biasing elements 48a, 48b and the engaging aperture 54 is lifted out of engagement with the locking post 36. Thereafter, the blister card 12 is grasped near the trailing edge E2 and pulled through the open end 32. In the illustrated embodiment, the blister card 12 is prevented from being fully extracted as the retainer structure 47 is received in the aperture 54. In alternative embodiments, the blister card 12 can be fully extracted or can be indexed or metered, thereby allowing access to a limited number of blisters 52 at a time.

The first embodiment teaches the advantages of a lockable container 10. However, under certain conditions the locking feature is not needed or desired. For example, if children are not present, are only present during certain times, or do not have access to the lockable container 10, it may be desirable to deactivate the locking feature of the lockable container 10. Thereby, the user, presumably an adult who owns the container and its contents or for whom the contents of the lockable container 10 are intended, can access the contents of the lockable container 10 without repeatedly manipulating the child-resistant locking feature.

Exemplary tools for selectively deactivating the locking feature of the locking container 10 (“deactivation tools”) are now described. In some of the embodiments, the deactivation tool includes a mechanism that displaces or otherwise disables the release button 40. In other embodiments, the deactivation tool includes a mechanism that covers or otherwise disables the engaging mechanism 36. In still other embodiments, the deactivation tool includes a mechanism that inhibits or otherwise prohibits the receiving mechanism 54 from engaging the engaging mechanism 36. Where elements of the embodiments that are described hereinafter are substantially similar to elements that have been described in the first embodiment, further description will not be provided where doing so would be repetitive. Rather, the description hereinafter will speak to the differences between the embodiments.

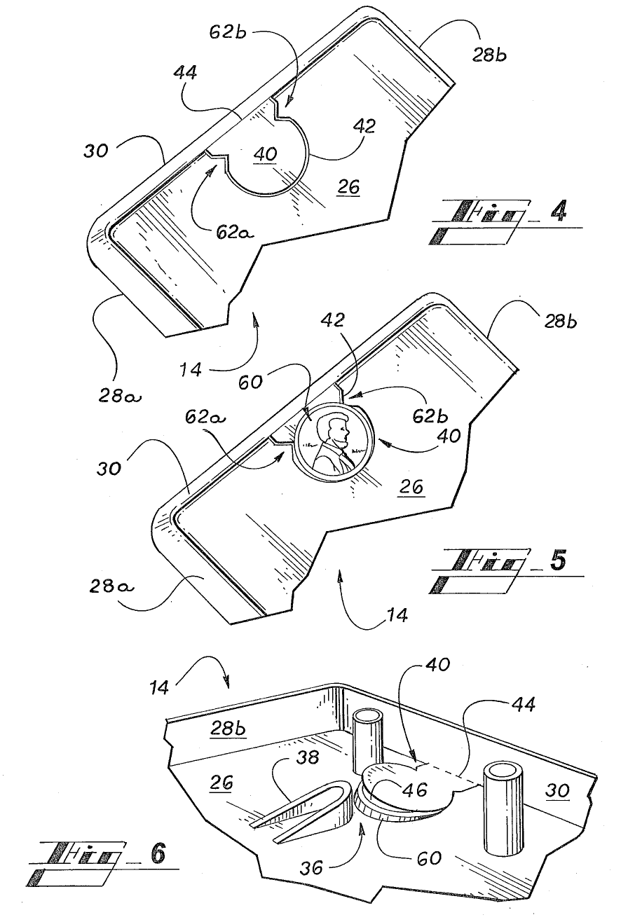

Referring to another exemplary embodiment illustrated in FIGS. 4-6, the deactivation tool can include a flat disc 60, such as a coin or a washer having, here, a shape that corresponds to the shape of the release button 40. The flat disc 60 has a selected thickness such that an edge thereof can be wedged in between the release button 40 and the base wall 26 to displace the release button 40 by a selected amount. Referring to FIG. 6, the disc 60 can be wedged in between the release button 40 and the base wall 26 until the edge of the disc 60 contacts the locking post 36. The release button 40 is held in a displaced position such that the aperture 54 is prevented from receiving the locking post 36 when the blister card 12 is inserted into the sleeve 14.

In this embodiment, the slot 42 that defines the release button 40 includes two securing tabs 62a, 62b that extend to support and position the disc 60. While the illustrated embodiment includes two securing tabs 62a, 62b, there can be more or less than two securing tables 62a, 62b. It is contemplated that the disc 60 can have some transverse movement as it is wedged between the release button 40 and the base wall 26 in embodiments where the slot 42 is shaped as in the embodiment illustrated in FIGS. 1-3.

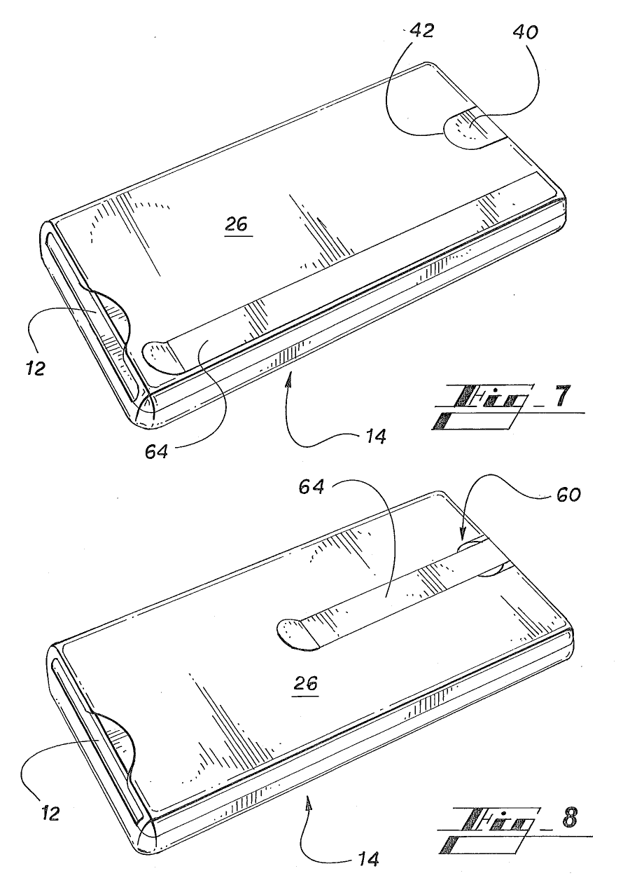

As illustrated in FIGS. 4-6, the disc 60 can be maintained in position against the base wall 26 by the release button 40. However, in some embodiments, the amount of friction between the disc 60 and the sleeve 14 may not be sufficient to allow the disc 60 to be held in such a wedged position. According to an exemplary method and referring to another exemplary embodiment illustrated in FIGS. 7 and 8, tape 64 is used to secure the disc 60 in place. Specifically, once the disc 60 is wedged in place to displace the release button 40, the tape 64 is applied over the disc 60 and across the walls of the sleeve 14.

It should be understood that the shape of the disc 60 can be altered and yet substantially perform the same functionality described herein. For example, the disc 60 can be a paperclip, a bar or rectangular shaped item, a wedge that gradually increases in thickness along its length, or some other item.

In alternative embodiments, the disc 60 can include a notch (best shown in FIG. 14) that is dimensioned and positioned to receive the locking post 36 such that the disc 60 can be wedged further between the base wall 26 and release button 40. According to another alternative embodiment, the disc 60 or an alternative wedge structure can be integral to a clip that attaches to the edge of the base wall 26 defined by the slot 42 to position the disc 60 for displacing the release button 40.

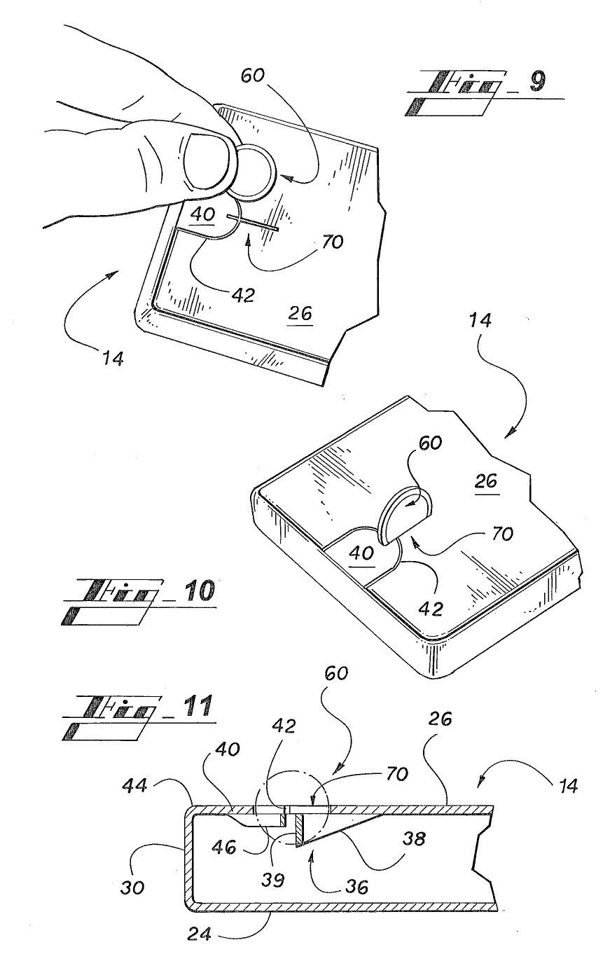

Referring now to another exemplary embodiment of the present disclosure illustrated in FIGS. 9-11, the sleeve 14 includes a slot 70 into which a tool, for example, a disc 60, is inserted to disable the locking feature of the lockable container 10. The slot 70 can be dimensioned and positioned to receive and position the disc 60 such that an edge of the disc 60 extends into the compartment near the distal end of the displaced release button 40. A slot (not shown) can also be formed in the locking post 36 and can be substantially coplanar with the slot 70.

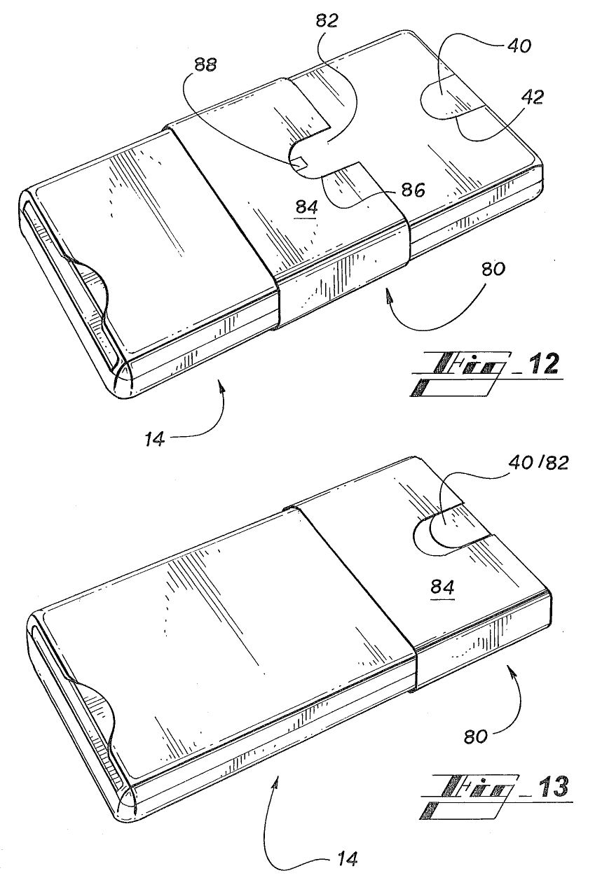

The illustrated slot 70 is substantially straight and disposed in the base wall 26 to intersect the U-shaped slot 42. The width of the slot 70 can be slightly less than the thickness of the disc 60 such that the disc 60 is press fit into the slot 70 or is otherwise held in place by friction. In addition or alternatively, the length of the slot 70 can be determined such that the disc 60 extends into the compartment from the base wall 26 by a selected distance. In this embodiment, the edge of the disc 60, when inserted into the slot 70, can prevent the aperture 54 from engaging the locking post 36 as the blister card 12 is inserted into the sleeve 14, as best shown in FIG. 11

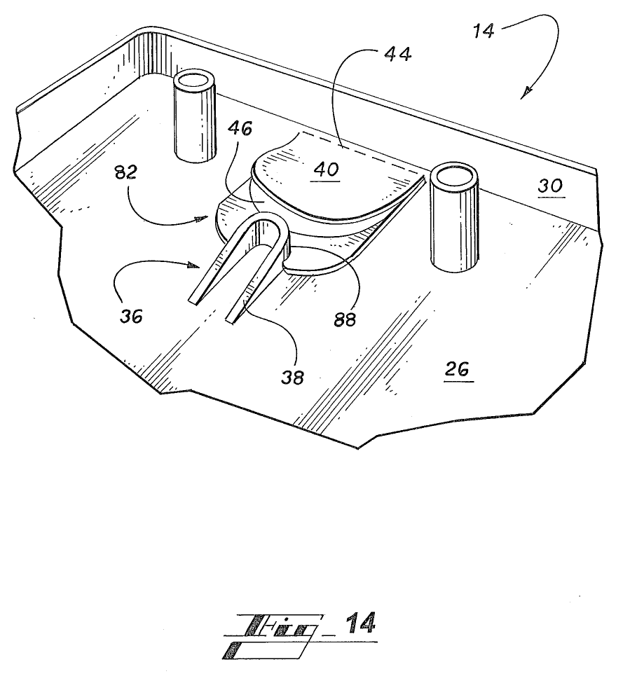

Turning to another exemplary embodiment of the present disclosure illustrated in FIGS. 12-14, a sliding disablement structure 80 includes a flap 82 that is struck from a jacket 84. The jacket 84 can be wrapped around the top, base, and side walls 24, 26, 28a, 28b and can slide lengthwise or longitudinally over the outside of the sleeve 14 between the open end 32 and the end wall 30. While the jacket 84 is illustrated as encompassing or wrapping around the sleeve 14, it will be appreciated that the jacket 84 can be a substantially planar sheet that does not encompass the sleeve 14. As will be explained below, the flap 82 can also be a stand-alone tool, and therefore may not be attached to any other material. The illustrated flap 82 is defined by a U-shaped opening in the material 86, for example, a cut line, an aperture, or a severance line, so as to be substantially the same shape as, but slightly smaller than, the release button 40. The flap 82 is positioned on the jacket 84 so as to longitudinally align with the release button 40 as the jacket 84 slides over the sleeve 14. Additionally, a notch 88 can be included in the distal end of the flap 82.

To operate the sliding disablement structure 80, the jacket 84 is slid towards the end wall 30 until the flap 82 substantially aligns with the release button 40. Thereafter, as best shown in FIG. 14, the flap 82 is pressed to displace the release button 40 and the jacket 84 is slid towards the open end 32 such that the flap 82 is wedged between the push button 40 and the base wall 26. The optional notch 88 can be dimensioned and positioned to receive the locking post 36 so as to allow the flap 82 to be wedged further between the push button 40 and the base wall 26.

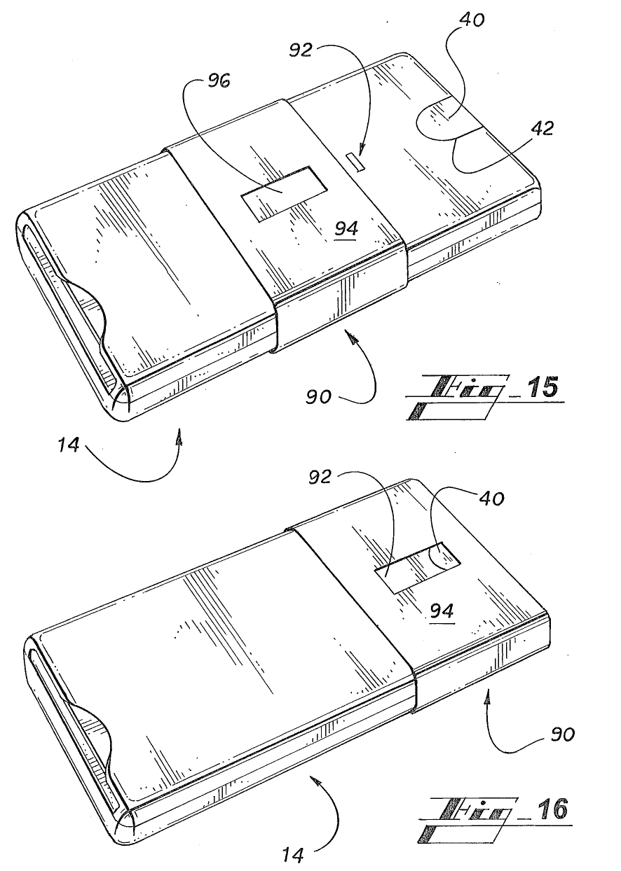

Another embodiment of the present disclosure includes an alternative sliding disablement structure 90 and is illustrated in FIGS. 15-17. In this embodiment, the sleeve 14 includes a slot 92 that is disposed in the base wall 26 and can be located near the sloped surface 38 of the locking post 36. The sliding disablement structure 90 can include a jacket 94 that is wrapped around the sleeve 14 and that can slide with respect to the sleeve 14 as described above for the jacket 84. The illustrated jacket 94 includes a tab 96 that is hingedly connected to the jacket 94 and that is longitudinally aligned with the slot 92. As explained above with respect to the jacket 84, the jacket 94 can be a planar sheet and need not encompass the sleeve 14. Similarly, the tab 96 can be a stand-alone tool that is not attached to any other material.

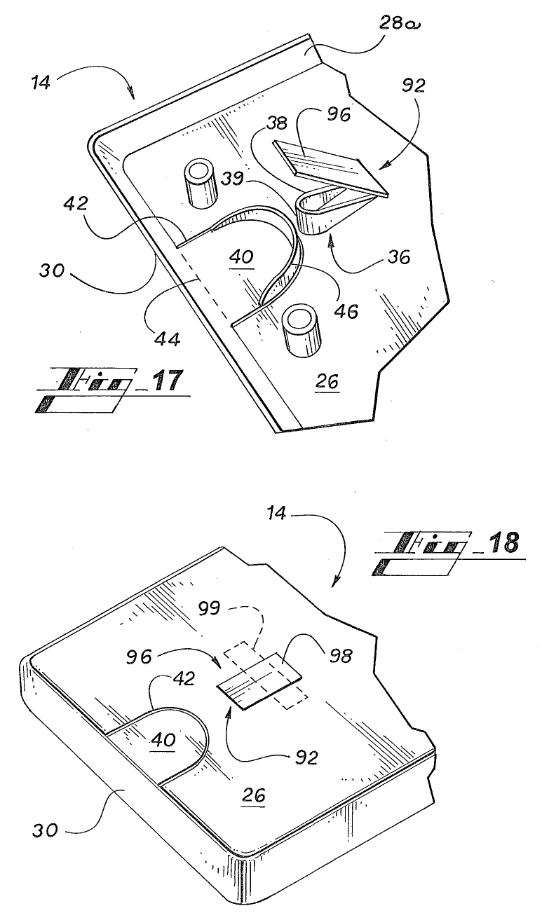

To operate the sliding disablement structure 90, the jacket 94 is slid towards the end wall 30 and the tab 96 is fed through the slot 92. Thereby, as is best illustrated in FIG. 17, the tab 96 can extend into the compartment and can cover the locking post 36 such that the aperture 54 is prevented from receiving the locking post 36.

In alternative embodiments, the tab 96 is utilized without the jacket 94. For example, with reference to another exemplary embodiment of the present disclosure illustrated in FIG. 18, the tab 96 can be fed through the slot 92 to cover the locking post 36 and an outer end 98 can be attached to the outside surface of the base wall 26, rather than being connected to the jacket 94. The outer end 98 can be attached to the base wall 26 with tape 99, as shown in FIG. 18, or with other securing mechanisms such as adhesive, VELCRO®, mechanical fasteners, combinations thereof, and the like.

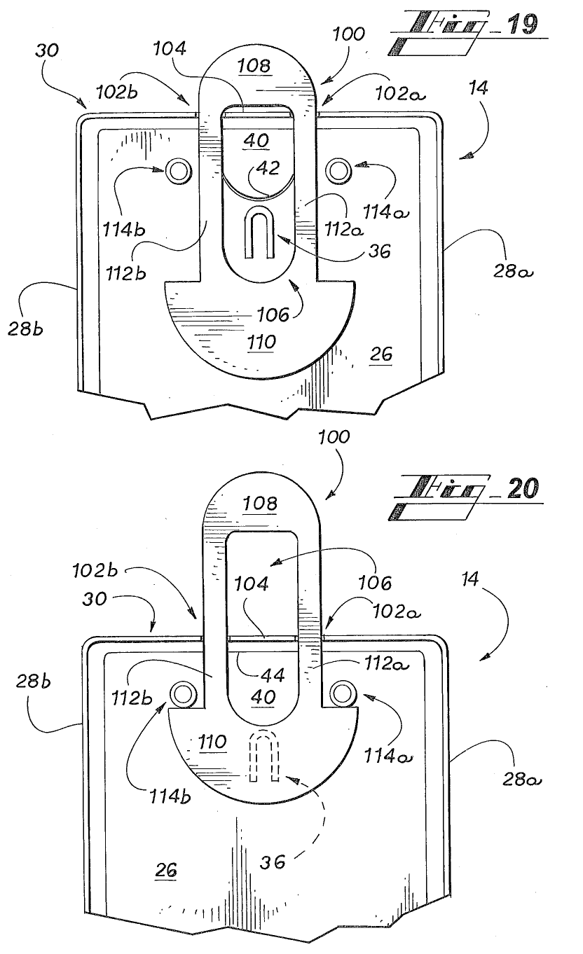

Another exemplary embodiment of the present disclosure is illustrated in FIGS. 19 and 20 and includes a pull tab structure 100 that slides to disable the locking feature. In the illustrated embodiment, the sleeve 14 includes slots 102a, 102b that are disposed in the end wall 30 and that are separated by a stopper portion 104 of the end wall 30.

The illustrated pull tab structure 100 is substantially flat and includes an elongated opening 106 that extends longitudinally. The pull tab structure 100 further includes an outer end 108, an inner end 110, and legs 112a, 112b that are defined by the elongated opening 106. The stopper portion 104 is received in the elongated opening 106 and the legs 112a, 112b are received in the slots 102a, 102b so the pull tab structure 100 is able to move between first and second positions. As shown in FIG. 19, the pull tab structure 100 can be fully inserted into the compartment to be in a first open position. When the pull tab structure 100 is in the first, open position, the locking post 36 is able to receive the blister card aperture 54, and the inner end 110 is positioned forward of the sloped surface 38 of the locking post 36. Further, the locking post 36 is received in the elongated opening 106, and the end of the elongated opening 106 adjacent the outer end 108 is substantially in contact with the stopper portion 104. It should be noted that the elongated opening 106 can be dimensioned and positioned such that the push button 40 can displace therethrough to provide the normal releasing operability.

To disable the locking feature of the locking container 10, the outer end 108 is engaged to pull the pull tab structure 100 to the second, closed position where the inner end 110 covers the locking post 36, as shown in FIG. 20. In the illustrated embodiment, the inner end 110 is shaped to contact stopper posts 114a, 114b when the pull tab structure 100 is in the second position. As mentioned above, covering the locking post 36 prevents the aperture 54 from receiving the locking post 36 as the blister card 12 is received in the sleeve 14.

The pull tab structure 100 is not limited to the shape or structure illustrated herein. Rather, the pull tab structure can include a single leg that slides within a single slot in the end wall 30. Further, the end wall 30 can provide the stop feature for the pull tab structure when it is in the second position.

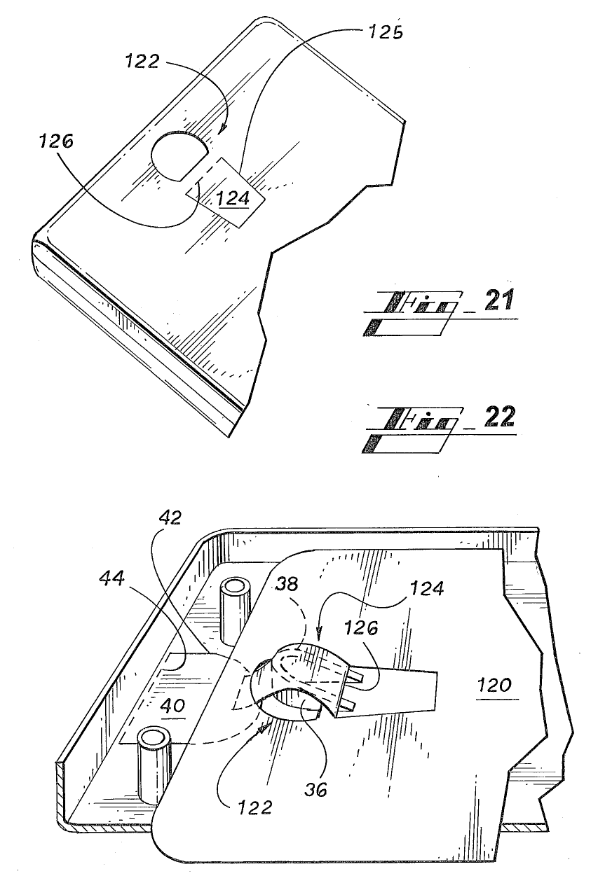

Referring to FIGS. 21-23, according to another exemplary embodiment of the present disclosure, an auxiliary card 120 provides a deactivation tool. The illustrated auxiliary card 120 includes an aperture 122 and a flap 124. The aperture 122 is dimensioned and positioned to receive the locking post 36. The flap 124 is struck from the auxiliary card 120 along a severance line 125 and is hingedly connected to the auxiliary card 120 along a fold line 126, which is adjacent the aperture 122.

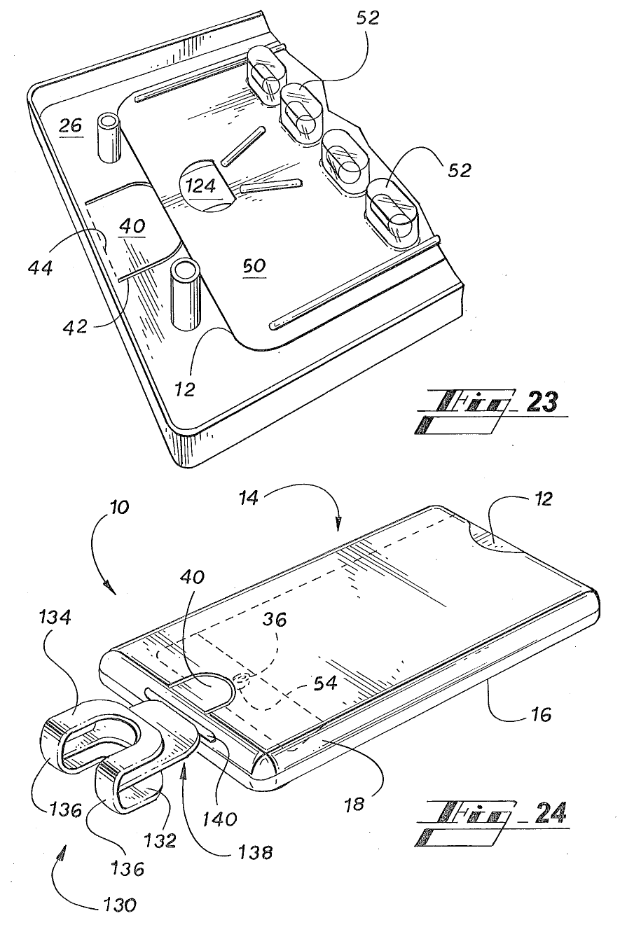

Turning to FIG. 22, to disable the locking feature, the flap 124 is folded along the fold line 126 toward the aperture 122 and the card 120 is then inserted into the compartment with the flap 124 extending toward the top wall 24. Once the aperture 122 receives the locking post 36, the flap 124 is positioned to cover the locking post 36. Referring now to FIG. 23, the blister card 12 can thereafter be inserted into and removed from the compartment, sliding over the card 120, without the aperture 54 receiving the locking post 36.

Another embodiment includes structures similar to the flap 124 and the aperture 122 included directly on the slideable platform 12 instead of, or in addition to being included on an auxiliary card 120. In any embodiments including a flap 124 and aperture 122, the flap 124 can be folded up and through the aperture 122 to prevent the locking post 36 from engaging the aperture 122. The flap 124 can also be folded under the aperture 122 and taped or otherwise secured to prevent the locking post 36 from engaging the aperture 122. It should be understood that if the features of the flap 124 and aperture 122 are included with the slideable platform 12, the functions of the aperture 122 and the aperture 54 can both be provided by a single aperture.

FIG. 24 illustrates another exemplary embodiment of the present disclosure. In this embodiment, the deactivation tool can include a deactivation clip 130. The illustrated deactivation clip 130 includes a base engaging arm 132 and top engaging arm 134 connected by an edge 136, and an attached key 138. It should be understood, however, that the key 138 does not require the engaging arms 132, 134 or the edges 136. The key 138 can be inserted into the sleeve 14 as a stand alone tool. Alternatively, the key 138 can include one engaging arm 132 or 134.

In practice, the user releases the slideable platform 12 as described above and inserts the key 138 through an access port 140 such that the key 138 prevents the engaging mechanism 36 from engaging the receiving mechanism 54. As such, the slideable platform 12 can be inserted into the sleeve 14, withdrawn from the sleeve 14, and the contents of the slideable platform 12 can be removed, as described above, without further manipulation of the release button 40.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A storing and dispensing system, comprising:
a sleeve, a sliding platform, and a deactivation tool;
the sleeve comprising:
a first side connected to a second side to form a void for receiving the sliding platform;
an open end configured to permit the sliding platform to translate between a first position and a second position; and
a first engaging element positioned substantially within the void;
the sliding platform comprising a second engaging element for engaging the first engaging element; and
wherein the deactivation tool is selectively positioned to prevent the first engaging element from engaging the second engaging element.

2. The system of claim 1, wherein the first engaging element comprises a post.

3. The system of claim 2, wherein the second engaging element comprises an aperture.

4. The system of claim 1, wherein the sleeve further comprises a release proximate the first engaging element, and the deactivation tool further comprises an edge that can at least partially displace the release.

5. The system of claim 4, wherein the edge further comprises a notch.

6. The system of claim 1, wherein the sleeve further comprises at least one securing tab for retaining at least a portion of the deactivation tool when the deactivation tool is positioned to prevent the first engaging element from engaging the second engaging element.

7. The system of claim 1, wherein the deactivation tool is substantially disc-shaped.

8. The system of claim 1, wherein the sleeve further comprises a slot through which the deactivation tool is selectively inserted to prevent the first engaging element from engaging the second engaging element.

9. The system of claim 8, wherein the deactivation tool is substantially disc-shaped.

10. The system of claim 8, wherein the deactivation tool comprises a flap.

11. The system of claim 10, wherein the flap is connected to a jacket, and the jacket is slideably coupled to the sleeve.

12. The system of claim 1, wherein the deactivation tool comprises a slideable card.

13. The system of claim 12, wherein the slideable card comprises a flap.

14. The system of claim 13, wherein the slideable card further comprises a third engaging element, wherein the third engaging element engages the first engaging element and the flap prevents the second engaging element from engaging the first engaging element.

15. A selectively lockable container, comprising:
a sleeve, a sliding platform, and a deactivation tool insertion port;
the sleeve comprising:
a first side connected to a second side to form a void for receiving the sliding platform;
an open end configured to permit the sliding platform to translate between a first position and a second position; and
a first engaging element positioned substantially within the void;
the sliding platform comprising a second engaging element for engaging the first engaging element; and
the deactivation tool insertion port comprising an opening in the sleeve through which at least a portion of a deactivation tool is passed to selectively prevent the first engaging element from engaging the second engaging element.

16. The container of claim 15, wherein the deactivation tool insertion port comprises the open end.

17. The container of claim 15, wherein the first engaging element comprises a post and the second engaging element comprises an aperture.

18. The container of claim 15, wherein the deactivation tool insertion port comprises an aperture that at least partially defines the release.

19. The container of claim 18, further comprising a release proximate the first engaging element, and wherein the deactivation tool selectively moves the release into a disengagement position, whereat the first engaging element is prevented from engaging the second engagement element.

20. The container of claim 19, wherein the sleeve further comprises at least one securing tab for retaining at least a portion of the deactivation tool when the deactivation tool is used to move the release into the disengagement position.

21. The container of claim 20, wherein the deactivation tool is substantially disc-shaped.

22. The container of claim 15, wherein the deactivation tool comprises a flap.

23. The container of claim 22, wherein the flap is slideably coupled to the sleeve.

24. The container of claim 15, further comprising an attachment mechanism configured to attach the deactivation tool to the sleeve.

25. The container of claim 24, wherein the attachment mechanism comprises tape.

26. A storing and dispensing system, comprising:
a sleeve, a sliding platform, and a deactivation clip;
the sleeve comprising:
a first side connected to a second side to form a void for receiving the sliding platform;
an open end configured to permit the sliding platform to translate between a first position and a second position; and
a first engaging element positioned substantially within the void;
the sliding platform comprising a second engaging element for engaging the first engaging element; and
the deactivation clip comprising a key configured to prevent the first engaging element from engaging the second engaging element.

27. The system of claim 26, wherein the first engaging element comprises a post.

28. The system of claim 27, wherein the second engaging element comprises an aperture.

29. A deactivation clip for selectively preventing a first engaging element from engaging a second engaging element, comprising a key configured for insertion into a lockable case through an access port formed in the lockable case.

30. The deactivation clip of claim 29, further comprising at least one engaging edge attached to the key.

31. The deactivation clip of claim 30, further comprising at least one engaging arm connected to the at least one engaging edge.

32. The deactivation clip of claim 31, wherein the deactivation clip comprises two engaging arms and two engaging edges.
